(19) United States
(12) Patent Application Publication
(10) Pub. No.: US 2016/0242025 A1
(43) Pub. Date: Aug. 18, 2016

(54) PORTING WIFI SETTINGS

(71) Applicant: APPLE INC., Cupertino, CA (US)

(72) Inventor: Jaseem ALIYAR, San Jose, CA (US)

(73) Assignee: Apple Inc., Cupertino, CA (US)

(21) Appl. No.: 14/915,635

(22) PCT Filed: Aug. 29, 2013
(86) PCT No.: PCT/US2013/057419

§ 371 Date: Feb. 29, 2016

(51) Int. Cl. H04W 8/24; H04W 76/02; H04W 12/06

(52) U.S. Cl. CPC H04W 8/24; H04W 12/06; H04W 76/02; H04W 84/12

(57) ABSTRACT

A wireless device configured to port a plurality of WiFi settings to a device that is paired to it provided. The wireless device can gain access to a wireless router, and then send over the settings (i.e., password, SSID) associated with the WiFi connection to a paired so that the paired device can access the same wireless router automatically without user input or intervention.

### FIELD OF THE DISCLOSURE

This relates generally to wireless communication between computing devices and WiFi access points, and more particularly to the transferring of settings associated with WiFi access between computing devices.

### BACKGROUND OF THE DISCLOSURE

Computing devices such as desktop computers, laptop computers, mobile phones, smartphones, watches, tablet devices and portable multimedia players are popular. These computing devices can be used for performing a wide variety of tasks, from the simple to the most complex.

In some instances, computing devices can communicate wirelessly over wireless networks. For example, computing devices can communicate over wireless networks based on the Institute of Electrical and Electronics Engineers (IEEE) 802.11 family of standards, also referred to as “WiFi”. The standards (including 802.11a, 802.11b and 802.11g) define frequency, modulation, data rates, and message formats for communicating information between devices. In general, in an 802.11 compliant wireless network (also referred to as a “WiFi network”), there is a designated “access point,” often with a wired connection to the Internet, that manages the WiFi network. Among other operations, the access point can route messages between networked client devices. The WiFi network often has a name (generally configurable by a network administrator interfacing with the access point,) which the access point can periodically broadcast, and client devices that know the name or can discover the network name from the access point's broadcast and can join the network by sending requests to join the access point. In some cases, the requests can additionally include a password or access key. The password or access key can be implemented using various encryption and security protocols such as WiFi Protected Access (WPA) and Wired Equivalent Privacy (WEP). Computing devices can communicate wirelessly over other communication standards as well. For example, computing devices can use Bluetooth, Bluetooth Low Energy (LE), Zigbee, etc.

When a user possesses multiple devices on their person that are capable of being connected to a WiFi access point, it may become cumbersome and tedious to connect each and every device individually to a wireless access point. It can be especially cumbersome if the wireless access point requires a password or some other authentication process for access.

### SUMMARY

This relates to a wireless device that can transmit and receive certain settings associated with WiFi connectivity to another paired wireless device. A first wireless device can be connected to a WiFi access point and once a connection is established, it can port a plurality of settings and information to a second wireless device that is paired to the first wireless device such that the second wireless device can connect to the wireless access point with minimal user intervention.

### BRIEF DESCRIPTION OF THE DRAWINGS

FIG. 1 illustrates a communication link between a wireless device and a wireless access point according to examples of the disclosure.

FIG. 2 illustrates an exemplary wireless device paired with another wireless device in order to delegate its WiFi network discovery to the paired device according to examples of the disclosure.

FIG. 3 illustrates an exemplary method for porting WiFi settings between paired wireless devices according to examples of the disclosure.

FIG. 4 illustrates an exemplary block diagram of a wireless device according to examples of the disclosure.

### DETAILED DESCRIPTION

In the following description of examples, reference is made to the accompanying drawings which form a part hereof, and in which it is shown by way of illustration specific examples of the disclosure that can be practiced. It is to be understood that other examples can be used and structural changes can be made without departing from the scope of the examples of this disclosure.

This relates to a method of porting WiFi settings between paired wireless devices in order to minimize a user's burden associated with having to connect multiple wireless devices to the same wireless access point.

Although examples disclosed herein may be described and illustrated herein in terms of the IEEE 802.11 standard communications protocol, it should be understood that the examples are not so limited, but are additionally applicable to other wireless communications protocols in which communication tasks can be delegated between devices. Furthermore, although examples may be described and illustrated herein in terms of wireless routers acting as wireless access points, it should be understood that the examples are also applicable to servers and other computing devices which can act as wireless access points.

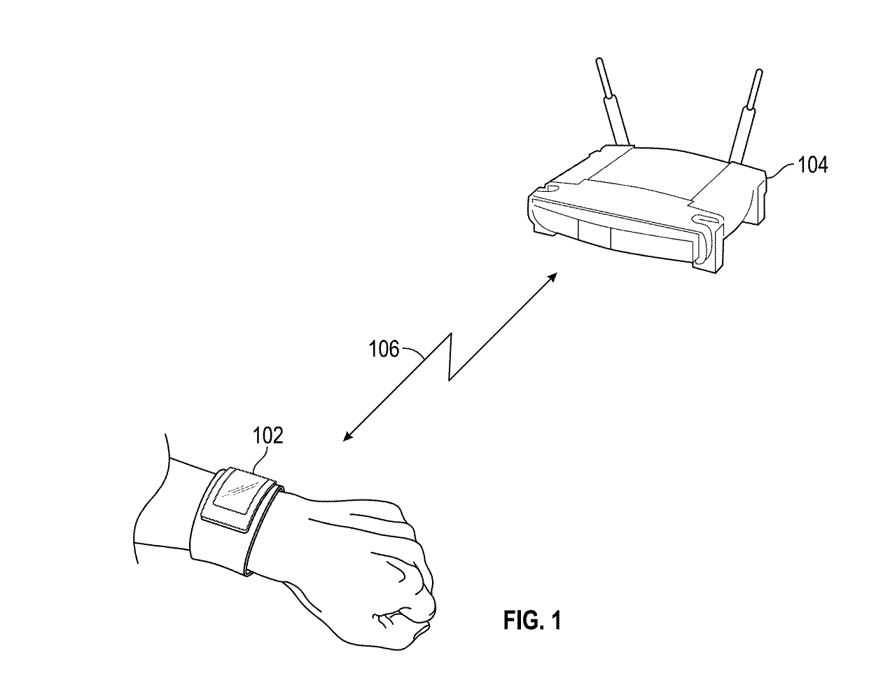

FIG. 1 illustrates a communication link between a wireless device and a wireless access point according to examples of the disclosure. Wireless device 102 can be linked to wireless access point 104 via wireless communication link 106. Wireless device 102 could be any portable or non-portable electronic device that has the ability to connect to a computer network wirelessly. Wireless access point 104 could be, for instance, a wireless router that allows wireless devices such as the one depicted at 102 to establish connections to it. Wireless access point 102 can be hard wired to the Internet using a standard Ethernet cable, and can provide Internet connectivity to devices connected to it such as device 102. As mentioned above, link 106 can be established using the IEEE 802.11 protocol.

The link can be established as follows. Wireless access point 104 can broadcast its presence periodically to alert proximate devices that it is available for connection. In one example, wireless access point 104 can broadcast a service set identifier (SSID) at periodic intervals to alert devices that are in proximity to its presence. A user of the device 102 can prompt the device to seek out wireless access points. Upon being prompted, device 102 can begin to “scan” for SSIDs being broadcast by wireless access points that are nearby. Once the scan is complete, the device 102 can present a list of found SSIDs, the user can then pick a wireless access point to connect with, and the link can be established per IEEE 802.11.

Once the user selects a particular SSID, the SSID and other information such as the WiFi connection associated with the SSID can be stored on the device such as on a list for future reference. In the future, the device can periodically scan for SSIDs without being prompted by the user. If the device 102 encounters an SSID of a wireless access point that is on the list, it can automatically connect to the wireless access point without being prompted by the user. The list can be populated with one or more SSID's that have been connected to in the past, such as a home network, a work network, school network, etc. If a known network, i.e., a network from the list, is encountered by the device during its periodic scans, the device can first recognize that it has encountered an SSID from list, and then automatically connect to it without requiring any prompting from the user.

Furthermore, some wireless access points can possess certain security provisions in order to protect the wireless access point from being accessed by unauthorized users. For instance a wireless access point can require that a user enter a password prior to being granted access to the wireless access point. In another example, the wireless access point may encrypt its communications with wireless devices using one of several encryption protocols such as WEP or WPA. As yet another example, in a public setting such as a hotel or a library, a user may be directed to agree to a terms of service contract before being allowed access to the wireless access point. Once a wireless device accesses a network for the first time, these security provisions can be stored in the wireless device such that in subsequent sessions with the wireless access point, the device can automatically supply the password or other necessary information/settings to authenticate the device. While in the example above, the information is described as security provisions, the disclosure should not be seen as so limiting and can include any information that would be pertinent to allowing a device to access a particular wireless access point.

When a user is in possession of only one wireless device, connecting the device to a wireless access point by entering a password or other authentication information may not be burdensome. However, if the user is in possession of multiple wireless devices such as a laptop, a tablet, or wearable device such as a smart watch and desires that each device have access to the wireless access point, having to log in each device to the wireless access point can be cumbersome and time consuming

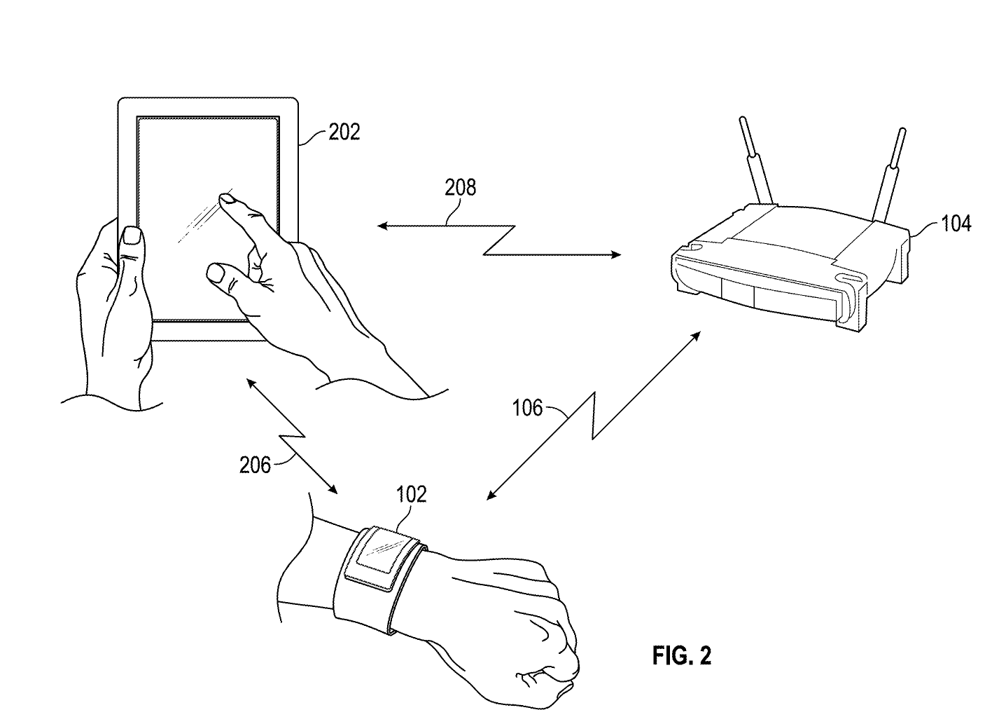

FIG. 2 illustrates an exemplary wireless device paired with another wireless device in order to port its WiFi network settings to the paired device according to examples of the disclosure. In this example, wireless device 102 can be paired with wireless device 202 (herein referred to as paired device 202). Pairing can refer to wireless device 102 and paired device 202 establishing a direct communications link with one another. In some examples, wireless device 102 and paired device 202 can establish a communications link 206 using Bluetooth LE and its associated communications protocol. Bluetooth LE is used only as an example and the disclosure is not so limited, and can also include other known communication methods such as near field communication protocols (NFC). Once a link has been established between wireless device 102 and paired device 202, thus making the devices paired together, wireless device 102 and paired device 202 can share information with each other that can assist wireless device 102 with connecting to a wireless access point with minimal user intervention.

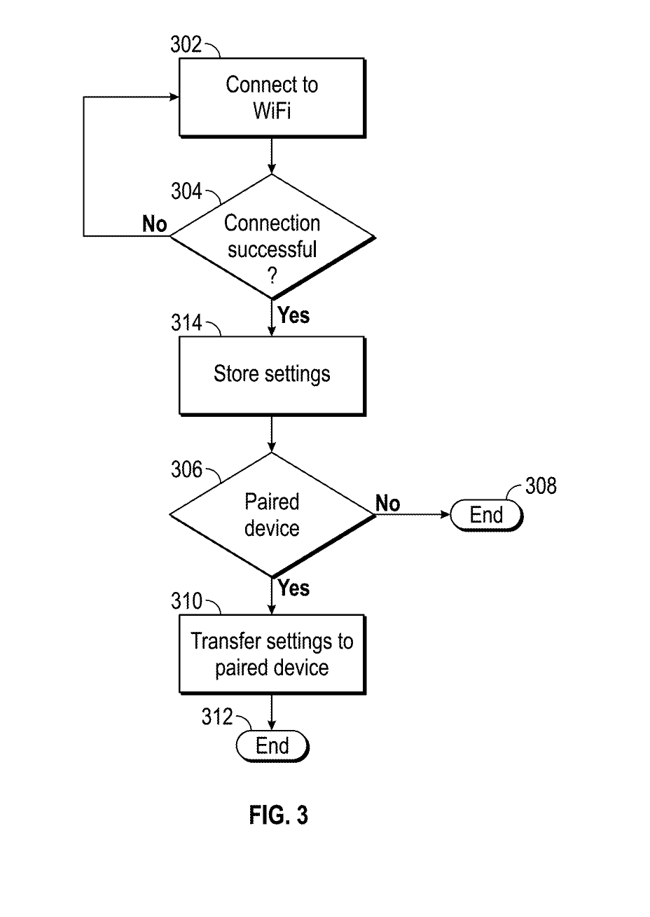

FIG. 3 illustrates an exemplary method for porting WiFi settings between paired wireless devices according to examples of the disclosure. At step 302 a wireless device such as a mobile telephone can connect to a wireless access point such as the one depicted at 104 of FIG. 2. The method can then move to step 304 where a determination is made if the connection was successful. If it is determined that the connection to the wireless access point was not successful, the method can repeat step 302 until a connection has been established. Once a connection to WiFi has been established, the wireless device can record the settings associated with the WiFi connection at step 314.

Examples of the type of information that can be stored by the device include the SSID of the wireless access point, the type of security protocol used by the link such as WEP and WPA, the password required to access the wireless access device, the type of WiFi connection, and any other information that may be needed in order for other devices to connect to the wireless access point.

After storing the information, the method can move to step 306. At step 306 the wireless device can determine whether or not a separate wireless device (such as a smart watch) is paired to the device as described above. If no device is paired, the method can end at step 308. If a paired wireless device is detected, the method can move to step 310 wherein the settings stored at step 314 can be transferred to the paired device. In some examples, a user may have to initially enable both the paired device and the wireless device to port their WiFi settings and/or receive WiFi settings from another device. The user enabling can be done by adjusting the settings of the paired device and the wireless device and may only have to be done once. In another example, if the wireless device authenticates itself to the wireless access point via its machine address (MAC address), the wireless device can transmit its MAC address to the paired device at step 310. The paired device can then engage in what is known in the art as “MAC spoofing,”; in other words, the paired device can hold itself out to the wireless access point as having the same MAC address as the wireless device that originally connected to the wireless access point. The method can terminate at step 312 once the settings have been transferred to the paired device.

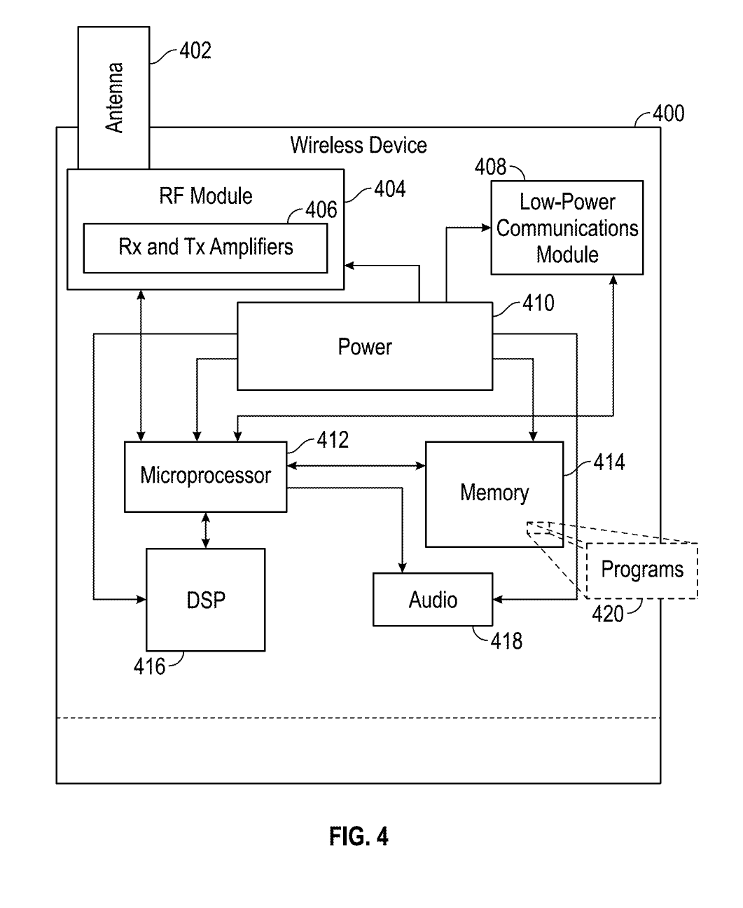

FIG. 4 illustrates an exemplary block diagram of a wireless device according to examples of the disclosure. The antenna 402 is designed to emit and receive electromagnetic waves according to a wireless or air interface standard such as IEEE 802.11. In one example, the antenna 402 is adapted to communicate with a wireless access point which provides the wireless device 400 with access to a broader network (e.g., the Internet). In many examples, the RF module 404 can have a transceiver adapted to convert the electromagnetic waves to current and ultimately to digital data, and conversely the digital data to current and then to electromagnetic waves (as applicable). One or more receive and or transmit amplifiers 406 may optionally be used to amplify signals for transmission, as is well known in the art. Wireless Device 400 can also contain a low-power communications module 408 that can be configured to operate low power, near field communications with proximal devices. As an example, module 408 can be configured to communicate with other devices using Bluetooth© LE.

The exemplary wireless device 400 of FIG. 4 can further have a central processing unit (such as integrated circuit microprocessor 412 and/or DSP, discussed below) which can be adapted to perform basic processing operations of the wireless device 400. Memory 414 can have one or more storage devices capable of storing signals as bits of data. Memory 414 may therefore have any combination of volatile memory or non-volatile memory in accordance with the scope of the present application (for example, DRAM, SRAM, flash memory, EAROM, EPROM, EEPROM, and/or myriad types of other memory modules).

The wireless device 400 can optionally contain an audio controller 418 and one or more digital signal processors (DSPs) 416 for audio, signal, image and/or video processing. A power source 410 such as a battery can provide power to the various components of the wireless device 400.

In one example, the microprocessor 416 is adapted to execute one or more software programs 420 stored in memory 414. The term “programs” can be understood to mean software modules that contain computer code to execute via a processor to operate the wireless device. The programs 420 can, upon detecting a specific control signal, modify the functionality of the wireless device 400 according to the type of signal detected, or alternatively, by the contents of the signal provided (e.g., commands embedded within a WiFi beacon as described elsewhere herein).

Therefore, according to the above, some examples of the disclosure are directed to a first wireless device, the first wireless device comprising: a first transceiver configured for connecting and communicating with a wireless access point; a second transceiver configured for communicating with a second wireless device; and a processor capable of: storing information associated with connecting to the wireless access point; determining if the first wireless device is connected to the second wireless device; and transmitting the stored information to the second wireless device if it is determined that the first wireless device is connected to the second wireless device. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the information associated with connecting to the wireless access point includes a type of security protocol used by the wireless access point. Additionally or alternatively to one or more of the examples disclosed above, in some examples, the information associated with connecting to the wireless access point includes a type of WiFi connection used by the wireless access point.

Some examples of the disclosure are directed to a method of configuring a transceiver used to communicate with a wireless access point to port to transmit information associated with connecting to the wireless access point to a wireless device, the method comprising: connecting with a wireless access point; storing information associated with connecting to the wireless access point; determining if a connection with the wireless device is present; and transmitting the stored information to the wireless device if the connection to the wireless device is present. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the associated with connecting to the wireless access point includes the type of security protocol used by the wireless access point. Additionally or alternatively to one or more of the examples disclosed above, in some examples, the information associated with connecting to the wireless access point includes the type of WiFi connection used by the wireless access point.

Some examples of the disclosure are directed to a non-transitory computer readable storage medium having stored thereon a set of instructions for configuring a transceiver used to communicate with a wireless access point, that when executed by a processor causes the processor to: connect with a wireless access point; store information associated with connecting to the wireless access point; determine if the device is connected to a second wireless device; and transmit the stored information to the second wireless device if it is determined that the device is connected to a second wireless device. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the associated with connecting to the wireless access point includes the type of security protocol used by the wireless access point. Additionally or alternatively to one or more of the examples disclosed above, in some examples, the information associated with connecting to the wireless access point includes the type of WiFi connection used by the wireless access point.

Some examples of the disclosure are directed to a first wireless device, the wireless device comprising: a first transceiver configured for communicating with a wireless access point; a second transceiver configured for communicating with a second wireless device; and a processor capable of: connecting the wireless device to the second wireless device via the second transceiver; receiving a plurality information from the second wireless device via the second transceiver, the information is associated with the second wireless device's connection to a wireless access point; and connecting with a wireless access point using the plurality of information provided by the second wireless device. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the information associated with connecting to the wireless access point includes the type of security protocol used by the wireless access point. Additionally or alternatively to one or more of the examples disclosed above, in some examples, the information associated with connecting to the wireless access point includes the type of WiFi connection used by the wireless access point.

Some examples of the disclosure are directed to A method of configuring a transceiver of a first wireless device used to communicate with a wireless access point, the method comprising: connecting the first wireless device to a second wireless device, such that the first wireless device and the second wireless device can communicate with one another; receiving information from the second wireless device, the information associated with the second wireless device's connection to a wireless access point; and connecting with a wireless access point using the information provided by the second wireless device. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the information associated with connecting to the wireless access point includes the type of security protocol used by the wireless access point. Additionally or alternatively to one or more of the examples disclosed above, in some examples, the information associated with connecting to the wireless access point includes the type of WiFi connection used by the wireless access point.

Some examples of the disclosure are directed to A non-transitory computer readable storage medium having stored thereon a set of instructions for configuring a transceiver of a first wireless device used to communicate with a wireless access point, that when executed by a processor causes the processor to: connect the first wireless device to a second wireless device, such that the first wireless device and the second wireless device can communicate with one another; receive information from the second wireless device, the information associated with the second wireless device's connection to a wireless access point; and connect with a wireless access point using the information provided by the second wireless device. Additionally or alternatively to one or more of the examples disclosed above, in some examples, the information associated with connecting to the wireless access point includes a password associated with obtaining access to the wireless access point. Additionally or alternatively to one or more of the examples disclosed above, in some examples, the information associated with connecting to the wireless access point includes the type of security protocol used by the wireless access point. Additionally or alternatively to one or more of the examples disclosed above, in some examples, the information associated with connecting to the wireless access point includes the type of WiFi connection used by the wireless access point.

Although examples of this disclosure have been fully described with reference to the accompanying drawings, it is to be noted that various changes and modifications including, but not limited to, combining features of different examples, omitting a feature or features, etc., as will be apparent to those skilled in the art in light of the present description and figures.

1. A first wireless device, the first wireless device comprising:
a first transceiver configured for connecting and communicating with a wireless access point;
a second transceiver configured for communicating with a second wireless device; and
a processor capable of:
storing information associated with connecting to the wireless access point;
determining if the first wireless device is connected to the second wireless device; and
transmitting the stored information to the second wireless device if it is determined that the first wireless device is connected to the second wireless device.

2. The first wireless device of claim 1, wherein the information associated with connecting to the wireless access point includes a password associated with obtaining access to the wireless access point.

3. The first wireless device of claim 1, wherein the information associated with connecting to the wireless access point includes a type of security protocol used by the wireless access point.

4. The first wireless device of claim 1, wherein the information associated with connecting to the wireless access point includes a type of WiFi connection used by the wireless access point.

5. A method of configuring a transceiver used to communicate with a wireless access point to transmit information associated with connecting to the wireless access point to a wireless device, the method comprising:
connecting with a wireless access point;
storing information associated with connecting to the wireless access point;
determining if a connection with the wireless device is present; and
transmitting the stored information to the wireless device if the connection to the wireless device is present.

6. The method of claim 5, wherein the information associated with connecting to the wireless access point includes a password associated with obtaining access to the wireless access point.

7. The method of claim 5, wherein the information associated with connecting to the wireless access point includes a type of security protocol used by the wireless access point.

8. The method of claim 5, wherein the information associated with connecting to the wireless access point includes a type of WiFi connection used by the wireless access point.

9. A non-transitory computer readable storage medium having stored thereon a set of instructions for configuring a transceiver of a first wireless device used to communicate with a wireless access point, that when executed by a processor causes the processor to:
connect with a wireless access point;
store information associated with connecting to the wireless access point;
determine if the device is connected to a second wireless device; and
transmit the stored information to the second wireless device if it is determined that the device is connected to the second wireless device.

10. The non-transitory computer readable storage medium of claim 9, wherein the information associated with connecting to the wireless access point includes a password associated with obtaining access to the wireless access point.

11. The non-transitory computer readable storage medium of claim 9, wherein the information associated with connecting to the wireless access point includes a type of security protocol used by the wireless access point.

12. The non-transitory computer readable storage medium of claim 9, wherein the information associated with connecting to the wireless access point includes a type of WiFi connection used by the wireless access point.

13. A first wireless device, the first wireless device comprising:
a first transceiver configured for communicating with a wireless access point;
a second transceiver configured for communicating with a second wireless device; and
a processor capable of:
connecting the first wireless device to the second wireless device via the second transceiver;
receiving a plurality of information from the second wireless device via the second transceiver, the plurality of information associated with the second wireless device's connection to the wireless access point; and
connecting with the wireless access point using the plurality of information provided by the second wireless device.

14. The first wireless device of claim 13, wherein the plurality of information associated with connecting to the wireless access point includes a password associated with obtaining access to the wireless access point.

15. The first wireless device of claim 13, wherein the plurality of information associated with connecting to the wireless access point includes a type of security protocol used by the wireless access point.

16. The first wireless device of claim 13, wherein the plurality of information associated with connecting to the wireless access point includes a type of WiFi connection used by the wireless access point.

17. A method of configuring a transceiver of a first wireless device used to communicate with a wireless access point, the method comprising:
connecting the first wireless device to a second wireless device, such that the first wireless device and the second wireless device can communicate with one another;
receiving information from the second wireless device, the information associated with the second wireless device's connection to the wireless access point; and
connecting with the wireless access point using the information provided by the second wireless device.

18. The method of claim 17, wherein the information associated with connecting to the wireless access point includes a password associated with obtaining access to the wireless access point.

19. The method of claim 17, wherein the information associated with connecting to the wireless access point includes a type of security protocol used by the wireless access point.

20. The method of claim 17, wherein the information associated with connecting to the wireless access point includes a type of WiFi connection used by the wireless access point.

21. A non-transitory computer readable storage medium having stored thereon a set of instructions for configuring a transceiver of a first wireless device used to communicate with a wireless access point, that when executed by a processor causes the processor to:
connect the first wireless device to a second wireless device, such that the first wireless device and the second wireless device can communicate with one another;
receive information from the second wireless device, the information associated with the second wireless device's connection to the wireless access point; and
connect with the wireless access point using the information provided by the second wireless device.

22. The non-transitory computer readable storage medium of claim 21, wherein the information associated with connecting to the wireless access point includes a password associated with obtaining access to the wireless access point.

23. The non-transitory computer readable storage medium of claim 21, wherein the information associated with connecting to the wireless access point includes a type of security protocol used by the wireless access point.

24. The non-transitory computer readable storage medium of claim 21, wherein the information associated with connecting to the wireless access point includes a type of WiFi connection used by the wireless access point.
